(19) United States
(12) Patent Application Publication
(10) Pub. No.: US 2025/0217190 A1
(43) Pub. Date: Jul. 3, 2025

(54) CONTEXT-AWARE DEVICE CONFIGURATION PROFILES

(71) Applicant: Roku, Inc., San Jose, CA (US)

(72) Inventors: Gregory Garner, Key Colony Beach, FL (US); Robert Caston Curtis, Napa, CA (US); Carl Sassenrath, Reno, NV (US); Sunil Ramesh, Saratoga, CA (US); Michael Patrick Cutter, Golden, CO (US); Sudipto Nandi, San Jose, CA (US)

(21) Appl. No.: 18/400,882

(22) Filed: Dec. 29, 2023

(51) Int. Cl. G06F 9/50; G06F 9/48

(52) U.S. Cl. CPC G06F 9/5005; G06F 9/4881

(57) ABSTRACT

Disclosed herein are system, apparatus, article of manufacture, method and/or computer program product embodiments, and/or combinations and sub-combinations thereof, for implementing context-aware device configuration profiles. An example method can include determining a context associated with a client device; based on the context, determining to reduce a use of one or more resources of the client device by one or more components of the client device while the client device operates in the context, the one or more resources including a memory, one or more processors, one or more processor cores, and/or a power source; and in response to determining to reduce the use of the one or more resources by the one or more components while the client device operates in the context, adjusting a configuration profile of the client device, the adjusted configuration profile reducing the use of the one or more resources by the one or more components.

### BACKGROUND

### Field

This disclosure is generally directed to context-aware device configuration profiles, and more particularly to adjusting device configuration profiles based on context information.

### SUMMARY

Provided herein are system, apparatus, article of manufacture, method and/or computer program product embodiments, and/or combinations and sub-combinations thereof, for adjusting device configuration profiles based on context information.

In some aspects, a method is provided for adjusting device configuration profiles based on context information. The method can be implemented by a client device, such as an Internet-of-Things (IoT) device, a peripheral device, a mobile device (e.g., a laptop computer, a tablet computer, a head-mounted display (HMD), etc.), a desktop computer, a smart wearable device (e.g., a smart watch, smart glasses, etc.), a smart television, an edge device, among others. The method can include determining a context associated with the client device and based on the context, determining to reduce a use of one or more system resources of the client device by one or more components of the client device while the client device operates in the context. The one or more system resources can include a memory, one or more processors, one or more processor cores, a power source, and/or a sensor, among others. The method can further include, in response to determining to reduce the use of the one or more system resources by the one or more components while the client device operates in the context, adjusting a configuration profile of the client device. The adjusted configuration profile can reduce the use of the one or more system resources by the one or more components.

In some aspects, a system is provided for adjusting device configuration profiles based on context information. In some examples, the system can include a client device. Moreover, the system can include memory and one or more processors coupled to the memory and configured to determine a context associated with the system and based on the context, determine to reduce a use of one or more system resources of the system by one or more components of the system while the client device operates in the context. The one or more system resources can include the memory, the one or more processors, one or more processor cores, a power source, and/or a sensor, among others. The one or more processors can be further configured to adjust, in response to determining to reduce the use of the one or more system resources by the one or more components while the system operates in the context, a configuration profile of the system. The adjusted configuration profile can reduce the use of the one or more system resources by the one or more components.

In some aspects, a non-transitory computer-readable medium is provided for adjusting device configuration profiles based on context information. The non-transitory computer-readable medium can have instructions stored thereon that, when executed by a client device, cause the client device to determine a context associated with the client device and based on the context, determine to reduce a use of one or more system resources of the client device by one or more components of the client device while the client device operates in the context. The one or more system resources can include a memory, one or more processors, one or more processor cores, a power source, and/or a sensor, among others. The instructions can further cause the cause the client device to adjust, in response to determining to reduce the use of the one or more system resources by the one or more components while the client device operates in the context, a configuration profile of the client device. The adjusted configuration profile can reduce the use of the one or more system resources by the one or more components.

### BRIEF DESCRIPTION OF THE FIGURES

The accompanying drawings are incorporated herein and form a part of the specification.

FIG. 1 illustrates a block diagram of an example environment for implementing context-aware device configuration profiles, according to some examples of the present disclosure.

FIG. 2 illustrates a block diagram of an example system flow for implementing context-aware device configuration profiles, according to some examples of the present disclosure.

FIG. 3 illustrates a block diagram of an example use case for implementing context-aware device configuration profiles, according to some examples of the present disclosure.

FIG. 4 is a flowchart illustrating an example method for adjusting device configuration profiles based on context information, according to some examples of the present disclosure.

FIG. 5 is a flowchart illustrating another example method for adjusting device configuration profiles based on context information, according to some examples of the present disclosure.

FIG. 6 is a flowchart illustrating another example method for adjusting device configuration profiles based on context information, according to some examples of the present disclosure.

FIG. 6 is a flowchart illustrating an example method for coordinating device configuration profiles across client devices based on context information, according to some examples of the present disclosure

FIG. 7 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Client devices, such as Internet-of-Things (IoT) devices and/or end user devices (e.g., edge devices, peripherals, laptop computers, smartphones, tablet computers, head-mounted displays (HMDs), smart wearable devices, desktop computers, smart televisions, etc.), generally have less and/or more limited hardware resources (e.g., memory, storage, compute/processing resources, etc.) than backend systems such as servers, cloud/datacenter systems, etc. For example, to reduce cost, client devices are generally equipped with less memory and processing resources than backend systems. As a result, client devices are typically more constrained in the amount of data (e.g., software code, data objects, content items, etc.) they can store, process, and/or load in memory and/or the features/functionalities they can implement at any given time.

For example, the more limited resources at the client devices can result in less resources available at the client devices to store and process data at any given time, and a lower amount of features/functionalities that the client devices can implement at any given time. Moreover, as data and compute demands on a client device increase, the risk of the client device running out of resources and/or experiencing associated errors also increases. The increasing data and compute demands on the client device can further reduce or limit the resources available at the client device to handle additional data and/or compute demands. For example, the lower memory capabilities of a client device (e.g., as compared to higher-end systems such as backend systems) can reduce the amount of code that the client device can load in memory at any given time. In some cases, a client device can be equipped with additional hardware resources to increase the amount of data that the client device can store, process, and/or load in memory at any given time, as well as the features/functionalities that the client device can implement at any given time. However, the additional hardware resources can increase the cost of the client device, which may not be feasible or desirable.

Provided herein are system, apparatus, device, method (also referred to as a process) and/or computer program product embodiments, and/or combinations and sub-combinations thereof, for adjusting device configuration profiles (also referred to herein as device profiles or configuration profiles) based on context information. In some examples, the adjustment of a configuration profile of a client device can include, without limitation, reducing the amount of data (e.g., code, models, algorithms, software stacks, etc.) loaded on a memory of the client device, deactivating one or more hardware and/or software components of the client device, deactivating one or more features/functionalities of the client device, and/or otherwise adjusting one or more settings of the client device to reduce resource demands at the client device and/or the amount of available resources at the client device.

For example, in some cases, information about a context associated with a client device can be used to determine any data (e.g., code, models, algorithms, software stacks, data objects, etc.) that can be removed/unloaded from (or may not be loaded on) a memory of the client device (e.g., because such data does not need to be loaded on memory at the client device given the context associated with the client device). The client device can then be triggered to remove/unload (or prevent loading of) such data from memory in order to reduce the memory demands at the client device and increase the amount of memory available at the client device. As another example, information about a context associated with a client device can be used to determine any hardware, software, and/or features/functionalities of the client device that can be turned off at the client device or implemented at a reduced resource consumption mode (e.g., because such hardware, software, and/or features/functionalities are not needed by the client device given the context associated with the client device). The client device can then be triggered to turn off (or implement at a reduce resource consumption mode) such hardware, software, and/or features/functionalities at the client device in order to reduce the resource demands at the client device and increase the amount of resources available at the client device.

The context information can include information about an environment associated with the client device (e.g., a geographic location of the client device, whether the client device is located indoors or outdoors, light conditions in the environment, a temperature in the environment, a humidity in the environment, an install location of the client device, etc.), a power setting of the client device (e.g., whether the client device is battery powered or connected to an external power source, whether the client device is configured with a power restriction/limit, whether the client device includes any solar power cells, whether the client device has intermittent power, a battery capacity of the client device, etc.), capabilities supported by a network associated with the client device (e.g., IPv4 and/or IPv6 capabilities, WIFI capabilities (e.g., WIFI 4, 5, 6, and/or 7 capabilities), device components and/or capabilities of the client device (e.g., network capabilities, neural networks at the client device, bandwidth at the client device, processing capabilities, features/functionalities, etc.), regulatory factors (e.g., wireless channel restrictions, face recognition restrictions, data sovereignty restrictions, etc.), and/or any other factors associated with the client device. As further described herein, such context information can be used to adjust a device configuration profile (e.g., running software, activated hardware and/or software capabilities, data loaded in memory, battery/power usage, system settings, throttling settings, network settings, etc.) of the client device to reduce the resource demands at the client device and increase the available resources at the client device.

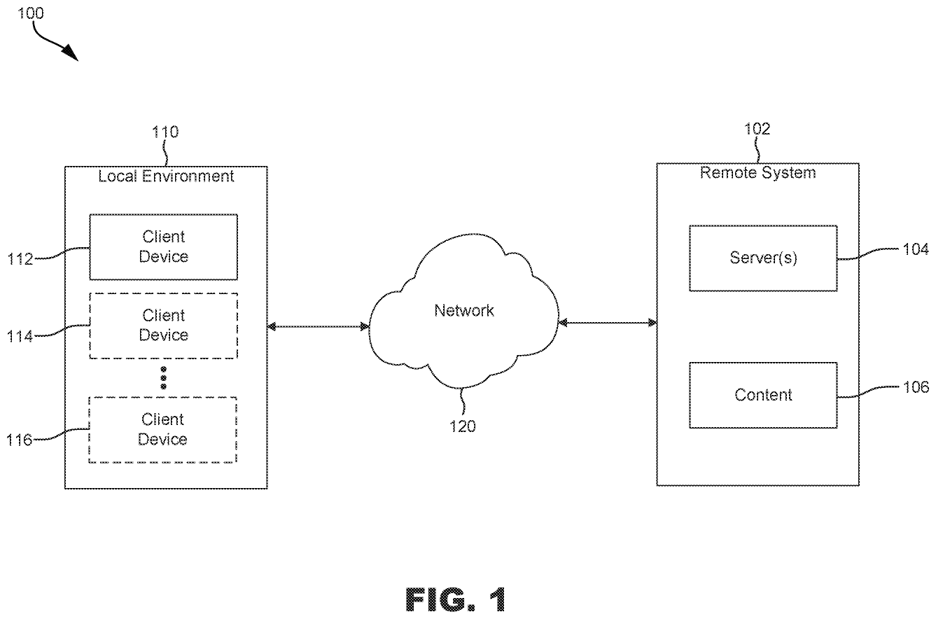

Various embodiments and aspects of this disclosure may be implemented using and/or may be part of an environment 100 shown in FIG. 1. It is noted, however, that the environment 100 is provided solely for illustrative purposes and is not limiting. Examples and embodiments of this disclosure may be implemented using, and/or may be part of, environments different from and/or in addition to the environment 100, as will be appreciated by persons skilled in the relevant art(s) based on the teachings contained herein. An example of the environment 100 shall now be described.

### Example Environment

FIG. 1 illustrates a block diagram of an example environment 100 for implementing context-aware device configuration profiles, according to some examples of the present disclosure. The example environment 100 may include a remote system 102 and a local environment 110. In some examples, the local environment 110 can represent a house, a room (e.g., a family room, a kitchen, a bedroom, bathroom, etc.), a hallway, a backyard, a balcony, a home theater, a garage, a building, a classroom, a library, a vehicle, a train, a boat, a plane, a theater, a stadium, an auditorium, a park, a bar, a restaurant, a business locale, or any other location or space.

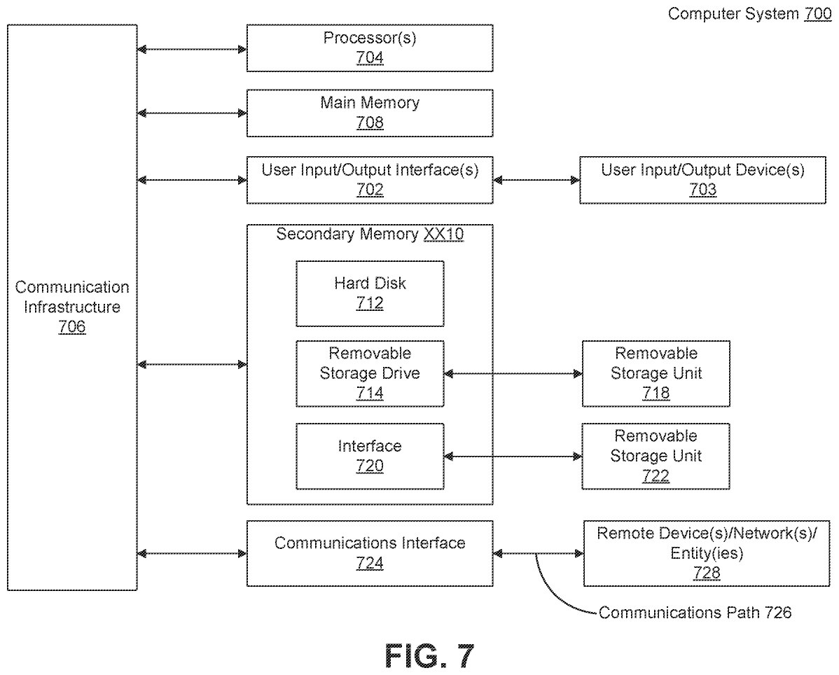

Moreover, the local environment 110 can include one or more client devices. For example, the local environment 110 may include client device 112. In some cases, the local environment 110 may optionally include one or more additional client devices, such as client device 114 and/or client device 116. The client devices 112-116 can each include or represent an Internet-of-Things (IoT) device, a sensor system, an access point, a smart appliance, a streaming media device, a set top box, a smart television, a client computer (e.g., a laptop computer, a tablet computer, a desktop computer, etc.), a smart phone, a smart wearable device (e.g., a smart watch, smart glasses, etc.), a head-mounted display (HMD), a camera system, a security system, a vehicle computing and/or sensor system, and/or a robotic device, to name a few examples. In some examples, any of the client devices 112-116 can include an electronic device equipped with one or more sensors such as, for example and without limitation, a camera sensor, an audio sensor (e.g., a microphone, etc.), an inertial measurement unit (IMU), a motion sensor, a light sensor, a temperature sensor, a humidity sensor, a touch sensor, a ranging sensor, a weight sensor, and/or any other sensor. The client devices 112-116 can additionally include other hardware components such as, for example and without limitation, one or more processing devices (e.g., a central processing unit, a graphics processing unit, a digital signal processor, an image signal processor (ISP), a field-programmable gate array, an application-specific integrated circuit, a microcontroller, a system-on-chip, etc.), one or more memory devices (e.g., a cache, a random-access memory device, a flash memory device, etc.), one or more storage devices (e.g., a hard drive, a solid-state drive, etc.), one or more communications devices (e.g., a network interface card, a wireless network interface card, a cellular antenna, a Bluetooth antenna, etc.), one or more output devices (e.g., a display, a speaker, etc.), one or more input devices (e.g., a touch screen, a microphone, a camera, a keyboard, a mouse, etc.), and/or any other hardware component. An example of hardware components that can be implemented by the client devices 112-116 is shown in FIG. 7, which illustrates an example computing system.

In some examples, the client devices 112-116 can communicate with each other (and optionally any other device with networking/communication capabilities in the local environment 110) via a local area network in the local environment 110, such as a WIFI network and/or mesh, a Bluetooth mesh, a Thread network, a Matter network, and/or an Ethernet network, to name a few examples. In some cases, the client devices 112-116 can communicate with each other via point-to-point connections and/or any other communication scheme. Moreover, the client devices 112-116 can communicate with the remote system 102 via a network(s) 120. The network(s) 120 can include, for example and without limitation, a wired and/or wireless network, a public network (e.g., a wide area network, etc.), a software defined network (SDN), an extranet, the Internet, a cellular network, a private network and/or virtual private network, and/or any other short range, long range, local, regional, global communications mechanism, means, approach, protocol and/or network, as well as any combination(s) thereof.

The remote system 102 can include and/or represent, for example, a remote server system, a cloud system, a datacenter, and/or any other remote system. In some examples, the remote system 102 can include one or more servers 104. The one or more servers 104 can include, for example and without limitation, one or more physical server computers, one or more virtualized servers (e.g., one or more software containers, one or more virtual machines, etc.), one or more cloud and/or application appliances, one or more distributed computing systems, and/or any other server systems. In some examples, the one or more servers 104 can provide, to the client devices 112-116, content 106, application services, management services, data storage services, processing services, compute resources/services, streaming services, artificial intelligence (AI) and machine learning (ML) services, software, computing functionalities, cloud services, record keeping services, logging services, troubleshooting services, deployment services, monitoring services, distributed computing services, software-as-a-service (SaaS), infrastructure-as-a-service (IaaS), platform-as-a-service (PaaS), cloud-as-a-service (CaaS), function-as-a-service (FaaS), and/or any other services.

The content 106 can include, for example and without limitation, metadata, audio data (e.g., music, etc.), videos, movies, television programs, multimedia, images, still pictures, text, graphics, gaming applications, advertisements, programming content, public service content, government content, local community content, software, log data, history data, client device data (e.g., client device locations, client device activity data, client device system information, data about one or more users associated with the client devices 112-116, data about the local environment 110, context data associated with the client devices 112-116, data about one or more service providers associated with the client devices 112-116, content from and/or for the client devices 112-116, etc.), streaming data, device preferences, device and/or user profiles, and/or any other content or data objects in electronic form. In some examples, metadata in the content 106 can include, without limitation, data about the content 106, one or more indexes of the content 106, timestamps, communication data, device information, and/or any other metadata.

As previously noted, the client devices 112-116 can have more limited hardware resources (e.g., less hardware resources, hardware resources with lower capabilities, etc.) than higher-end systems, such as the remote system 102. For example, the client devices 112-116 can have lower compute/processing, memory, storage, and/or power capabilities, which can limit/reduce the amount of processing they can perform, the amount of data they can hold in memory at any given time, their performance (e.g., processing speed, bandwidth, latency, etc.), the number and/or type of software services/components they can run, the amount of time and/or components they can run before running out of power, etc.

Moreover, if the client devices 112-116 run unused/unnecessary components (e.g., hardware and/or software components) that may utilize/consume resources at the client devices 112-116, such unused/unnecessary components can waste resources, reduce the amount of resources available at the client devices 112-116 to run other components that may otherwise be used/necessary (and/or of use) by/to the client devices 112-116, and/or limit/reduce what the client devices 112-116 can run at any given time. In some cases, such unused/unnecessary components can even prevent the client devices 112-116 from running other components (e.g., because of a lack of sufficient resources) that may otherwise be used/necessary (and/or of use) by/to the client devices 112-116. As further described herein, to avoid wasteful use of resources at the client devices 112-116, increase the amount of available resources at the client devices 112-116, improve the performance of the client devices 112-116, increase the lifespan of the client devices 112-116, and/or better manage resources at the client devices 112-116, the client devices 112-116 can be configured to (and/or triggered to) intelligently and dynamically reduce resource consumption by certain system components (e.g., software and/or hardware components that are unused/unnecessary at a given time) at the client devices 112-116 based on context information.

### Context-Aware Device Configuration Profiles

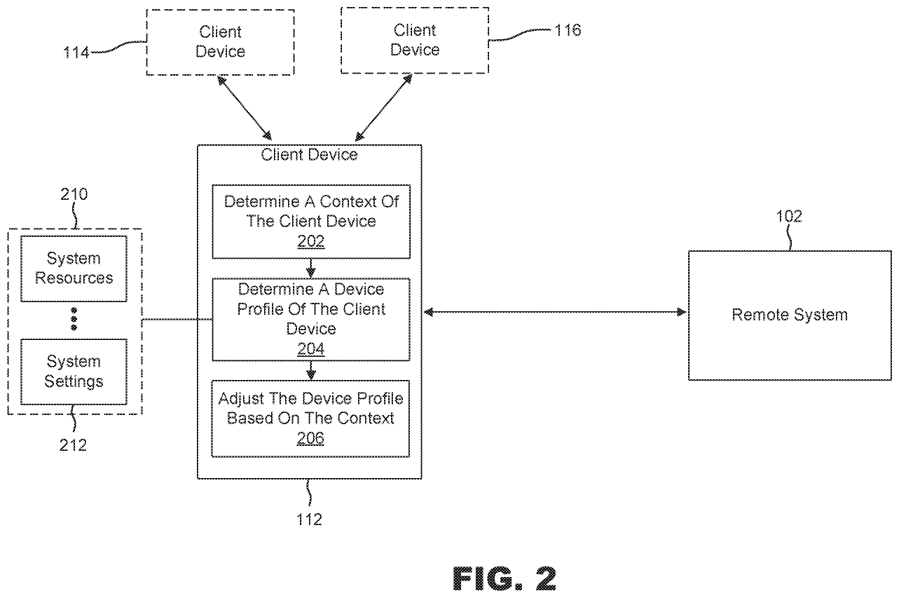

FIG. 2 illustrates a block diagram of an example system flow for implementing context-aware device configuration profiles, according to some examples of the present disclosure. The system flow can be used to implement context-aware device configuration profiles at any devices in the local environment 110. In the example shown in FIG. 2, the system flow is used to implement context-aware device configuration profiles at the client device 112, which can be used to intelligently and dynamically reduce resource consumption at the client device 112. However, in other examples, the system flow can additionally or alternatively be used to implement context-aware device configuration profiles at the client device 114 and/or the client device 116, which can be used to intelligently and dynamically reduce resource consumption at the client device 114 and/or the client device 116.

At block 202, the client device 112 can determine a context associated with the client device 112. The context can include any information about an environment (e.g., local environment 110) associated with the client device 112, power conditions and/or settings of the client device 112, device components and capabilities (e.g., software, hardware, etc.) of the client device 112, network information associated with the client device 112, regulatory information applicable to the client device 112, operating parameters of the client device 112, information about the client device 114 and/or the client device 116 in the local environment 110, and/or any other context information.

For example, in some cases, the context can include environment information such as, without limitation, a geographic location of the client device 112, whether the client device 112 is at an indoor or outdoor location, light conditions in the environment where the client device 112 is located, a temperature of the client device 112 and/or an environment where the client device 112 is located, a humidity of the environment where the client device 112 is located, an install location of the client device 112 (e.g., a garage, a living room, a hallway, a backyard, a kitchen, a bedroom, a theater, a conference room, an office, a front yard, a door, a vehicle, a building, a structure, a park, a parking lot, a driveway, etc.), a pose of the client device 112, a direction in which a sensor (e.g., a camera sensor, a microphone, etc.) of the client device 112 is pointed (e.g., whether the sensor is pointed towards/to an indoor location, an outdoor location, an entryway, a door, an object, a specific scene, etc.), and/or any other environmental cues.

In some examples, environment information such as location information, pose information, install location information, pointing direction of a sensor of the client device 112, temperature information, light conditions, humidity information, etc., can be determined based on network information (e.g., an Internet Protocol (IP) address associated with the client device 112), network service provider information associated with the client device 112, data from one or more sensors on the client device 112 (and/or on the client device 114 and/or the client device 116), data stored on the remote system 102, etc. For example, a location of the client device 116 can be determined based on an IP associated with the client device 112, information about the client device 112 and/or an associated user obtained from a network service provider used by the client device 112, recorded information at the remote system 102, global positioning system (GPS) information, scene information recognized from image data captured by a camera sensor, etc.

As another example, a temperature can be determined based on data from a temperature sensor, a humidity can be determined based on data from a humidity sensor, a pose of the client device 112 can be determined based on sensor data (e.g., image data from a camera sensor, IMU data, etc.), an install location and/or a scene of the client device 112 can be determined based on image data from a camera sensor, a pointing direction of a sensor of the client device 112 can be determined based on sensor data (e.g., image data from a camera sensor, IMU data, etc.), a scene visible by a camera sensor on the client device 112 can be determined based on image data captured by the camera sensor, etc. In some cases, a camera sensor (e.g., at the client device 112, the client device 114, and/or the client device 116) can capture image data, which can be transmitted to the remote system 102. The remote system 102 can process the image data to determine environment information such as, for example, a scene (e.g., recognized/detected from the image data) visible by a camera sensor of the client device 112, a pointing direction of a sensor of the client device 112, a pose of the client device 112, whether the client device is in an indoor or outdoor location, environmental conditions detected in a scene depicted in the image data, an install location of the client device 112, a weather condition in a scene depicted in the image data, etc.

In some cases, the context can additionally or alternatively include a power context of the client device 112 such as, for example and without limitation, whether the client device 112 is powered by a battery of the client device 112 (e.g., operating in battery mode) and/or powered by an external power source (e.g., a power outlet, an external power supply, etc.), whether the client device 112 has a solar power cell(s) used by the client device 112 to obtain at least some of the power used by the client device 112, whether the client device 112 is operating in a lower-power mode (e.g., a reduced power mode) or a higher-power mode, whether the client device 112 has intermittent power, a battery power level at the client device 112, any power limits set at or affecting the client device 112 (e.g., whether the client device 112 is powered by an external source set with a power limit, etc.), a power configuration at the client device 112, information about power needs of the client device 112, and/or any other power information associated with the client device 112.

In some cases, the context can additionally or alternatively include a network context such as, for example and without limitation, a type of network used by the client device 112 (e.g., a wireless network, an Ethernet network, a WIFI mesh network, a Bluetooth mesh network, a Matter network, a Thread network, etc.), whether the network used by the client device supports IPv4 and/or IPv6, what if any WIFI protocols is/are supported by the network (e.g., WIFI 4, WIFI 5, WIFI 6, WIFI 7, etc.), whether the network and/or the client devices 114-116 supports/support and/or uses/use Bluetooth data transport, a wireless band(s) and/or channel(s) used and/or supported by the network, etc. In some examples, the client device 112 can determine information about the network based on communications between the client device 112 and the network. For example, if an access point on the network supports IPv6, the access point may multicast router advertisement (RA) packets that include information indicating that the access point supports IPv6. Thus, the client device 112 can sniff packets from the access point to determine whether the access point has transmitted any RA packets indicating that the access point supports IPv6. As another example, when the client device 112 and the access point establish and/or negotiate a connection, the access point can announce any WIFI protocol supported by the access point, such as WIFI 4, WIFI 5, WIFI 6, WIFI 7, etc., which can allow the client device 112 to determine such information about the network (e.g., about the access point). As another example, the header of packets from the access point and/or the type of packets transmitted by the access point can provide the client device 112 certain network information and parameters. In some cases, the client device 112 can determine information about a connectivity between the client device 112 and the client devices 114-116 based on communications between the devices, such as a type of connectivity used (e.g., Bluetooth, etc.).

In some cases, the context can additionally or alternatively include information about device components and/or capabilities at the client device 112 such as, for example and without limitation, network capabilities at the client device 112, information about one or more neural networks at the client device 112 (e.g., a neural network size, a neural network functionality, etc.), a bandwidth of the client device 112, processing capabilities at the client device 112 (e.g., object detection/recognition, face recognition, image processing, media streaming, rendering capabilities, video capabilities, sensing capabilities, software capabilities, hardware capabilities, etc.), hardware components at the client device 112 (e.g., memory, processor(s), storage, sensor(s), display, peripheral(s), communication, etc.), software components at the client device 112 (e.g., software packages/code/libraries/stacks/etc., AI/ML models, algorithms, etc.), device settings (e.g., restrictions/limitations, parameters, preferences, etc.), and/or any other information about device components and/or capabilities.

In some cases, the context can additionally or alternatively include regulatory information applicable to the client device 112 such as, for example and without limitation, regulations (e.g., restrictions) on use of facial recognition, wireless channel restrictions, data sovereignty restrictions, etc.

At block 204, the client device 112 can determine a device profile (also referred herein as a device configuration profile or a configuration profile) of the client device 112. The device profile can include the resources at the client device 112 (e.g., total and/or available), settings at the client device 112, operating parameters at the client device 112, what hardware and/or software is running at the client device 112, resource usage information at the client device 112 (e.g., memory usage, processor usage, storage usage, power usage, etc.), etc. For example, the device profile can indicate any hardware and/or software resources of the client device 112, any configuration settings at the client device 112, resource utilization at the client device 112, what hardware and/or software components are consuming what resources at the client device 112 (and how much), etc. In some cases, the client device 112 can determine system resources 210 and/or system settings 212 at the client device 112, and determine the device profile at least partly based on the system resources 210 and/or system settings 212.

In some examples, the device profile can include network capabilities and/or usage at the client device 112, hardware components at the client device 112 (e.g., a memory device(s), a processor device(s), a storage device(s), a power source(s), a display device(s), a sensor device(s), a peripheral device(s), processor cores, and/or any other component), software components at the client device 112 (e.g., software code/packages/libraries/stacks/etc., AI/ML models, algorithms, etc.), processing capabilities (e.g., object detection and/or recognition, face recognition, image processing, rendering, sensing, memory, video, data processing, scene detection and/or recognition, etc.), operating parameters (e.g., thermal parameters, power mode, clock speed(s), device settings, operating restrictions/limits, etc.), and/or any other information about the client device 112.

At block 206, the client device 112 can adjust the device profile based on the context associated with the client device 112. The client device 112 can adjust the device profile to turn off, set to a lower operating mode, and/or unloaded from memory any components of the client device 112 that are not used/needed while the client device 112 operates in that context, and/or any components of the client device 112 that the client device 112 determines can be turned off, set to a lower operating mode, or unloaded from memory while the client device 112 operates in the context. The client device 112 can make such adjustment(s) in order to reduce or prevent the consumption of resources by such components and increase the resources available at the client device 112 for other uses by the client device 112, such as other components. The client device 112 can implement the adjusted device profile while the client device 112 is in the context, and similarly adjust the device profile if the client device 112 detects any changes in the context (or otherwise needs to change the device profile implemented by the client device 112).

In some examples, the client device 112 can use the context to determine any components (e.g., hardware and/or software components, etc.) of the client device 112 that are not used/needed while the client device 112 operates in that context and/or any components that can be turned off, set to a lower operating mode, or unloaded from memory, in order to increase the resources available at the client device 112. For example, the client device 112 can use the context to determine any network protocol/functionality/standard that is not supported by a network, access point, and/or device(s) (e.g., client device 114, client device 116) to which the client device 112 is connected, in order to deactivate any components at the client device 112 used to implement/support such network protocol/functionality/standard, set such components to a lower power mode, or unload such components from memory and thereby reduce or prevent resource consumption by such components.

To illustrate, if the context indicates that the client device 112 is connected to a network and/or device (e.g., an access point, a client device, etc.) that does not support IPv6, a specific WIFI version (e.g., WIFI 4, WIFI 5, WIFI 6, WIFI 7, etc.), and/or a specific wireless band or channel, the client device 112 can adjust the device profile to deactivate IPv6, the specific WIFI version, and/or the specific wireless band or channel, and/or to unload from memory any software used to implement/support IPv6, the specific WIFI version, and/or the specific wireless band or channel. This way, the client device 112 can increase the resources available at the client device 112 by deactivating and/or unloading from memory such unused/unnecessary components. Similarly, if the context indicates that the network or a device communicating with the client device 112 (e.g., an access point, client device 114, client device 116) does not use or support a specific protocol/standard/etc., the client device 112 can adjust the device profile to deactivate and/or unload from memory any components used to implement or support such protocol/standard/etc. For example, if the context indicates that the network and/or devices to which the client device 112 is connected does/do not support Bluetooth, Matter, and/or Thread, the client device 112 can adjust the device profile to deactivate and/or unload from memory any components used to implement and/or support Bluetooth, Matter, and/or Thread.

As another example, if the context indicates that a camera of the client device 112 is facing an indoor location and/or the camera does not have visibility to an outdoor location (e.g., because the client device 112 is at an indoor location), the client device 112 can determine that any software/models used to detect outdoor objects (e.g., vehicles, delivered packages, visitors in an entryway, outdoor landmarks, etc.) are unnecessary while the client device 112 operates in the context. Thus, the client device 112 can adjust the device profile to deactivate and/or unload from memory such software/models, and thereby free up resources at the client device 112.

As another example, if the context indicates that an environment of the client device 112 has a temperature above a threshold and/or a humidity above a threshold, the client device 112 can adjust the device profile to provide better thermal management, such as by throttling a processor clock speed, turning off a processor core(s), and/or otherwise turning off or reducing a power mode of one or more components that generate heat at the client device 112. If the context indicates that the client device 112 is operating in battery mode and/or that the client device 112 at least partly relies on power from a solar cell but the environment has low light conditions from which the solar cell can convert into electricity, the client device 112 can adjust the device profile to reduce or prevent a power consumption by one or more components of the client device 112 in order to conserve power. If the context indicates that the client device 112 is in an environment with an amount of ambient light above a threshold, the client device 112 can adjust the device profile to deactivate a light source at the client device 112 or reduce an intensity of the light emitted by the light source, in order to reduce or prevent an unnecessary consumption of resources by such light source.

As another example, if the context indicates that a regulation applicable to the client device 112 (e.g., because of a location of the client device 112) prohibits use of a certain feature, such as facial recognition or a wireless channel, the client device 112 can adjust the device profile to unload from memory any software/models used for such feature and/or otherwise deactivate such feature. Since the client device 112 cannot use such feature, the client device 112 can avoid unnecessary and wasteful consumption of resources by such feature.

As another example, if the context indicates that the client device 112 did not run a certain component (e.g., a hardware and/or software component) for a threshold period of time, the client device 112 can adjust the device profile to remove such code from the client device 112 to free up storage space at the client device 112.

As yet another example, if the context (and/or information from the client device 114, client device 116, and/or remote system 102) indicates that client device 114 and/or client device 116 is better suited to run a certain feature (e.g., because client device 114 and/or client device 116 has/have more available resources, more powerful resources, better tailored resources, etc.), the client device 112 can adjust the device profile to deactivate such feature and/or unload associated software from memory. Instead, the client device 112 can coordinate with the client device 114 and/or the client device 116 that such feature be implemented by the client device 114 and/or the client device 116. For example, if the client devices 114-116 have more power graphics processors and/or more available processing/memory resources than client device 112 and are thus better suited to run one or more AI/ML model(s), the client device 112 can adjust the device profile to deactivate such AI/ML model(s) and/or unload them from memory, and instead coordinate to have the client devices 114-116 run such AI/ML model(s) (e.g., either individually or in a distributed fashion).

In some cases, the client device 112 can individually decide to adjust the device profile to deactivate a component, reduce an operating mode of the component, or unload the component from memory. In other cases, the client device 112 can be instructed by or obtain confirmation from the remote system 102 before it makes such device profile adjustment. In some cases, certain device profile adjustments may be triggered by some form of consensus with other devices, such as client devices 114-116, access points in a network, the remote system 102, etc., or may need verification from multiple devices. For example, if the client device 112 is connected to an access point that does not support a particular network feature (e.g., IPv6, etc.), before the client device 112 adjusts the device profile to unload from memory (and/or deactivate) a component used to implement and/or support such network feature, the client device 112 may verify with another access point(s) in the network whether such access point(s) support that network feature. If the other access point(s) confirm that they do not support such network feature, the client device 112 can proceed to deactivate the associated component and/or remove it from memory. On the other hand, if the other access point(s) indicates that it supports such network feature, the client device 112 can decide to proceed or not proceed with deactivating the associated component and/or removing it from memory.

In some aspects, the client device 112 can detect changes in the context and make any other device profile adjustments based on the different context. In some cases, the remote system 102, the client device 114, the client device 116, and/or any other device can report information to the client device 112 that the client device 112 can use to detect a change in the context, which the client device 112 can use to determine whether (and how) to adjust the device profile. For example, the remote system 102, the client device 114, the client device 116, and/or any other device can report to the client device 112 sensor data, usage data, operating data, configuration data, network data, environmental data, and/or any other data, which the client device 112 can use to determine whether to adjust the device profile.

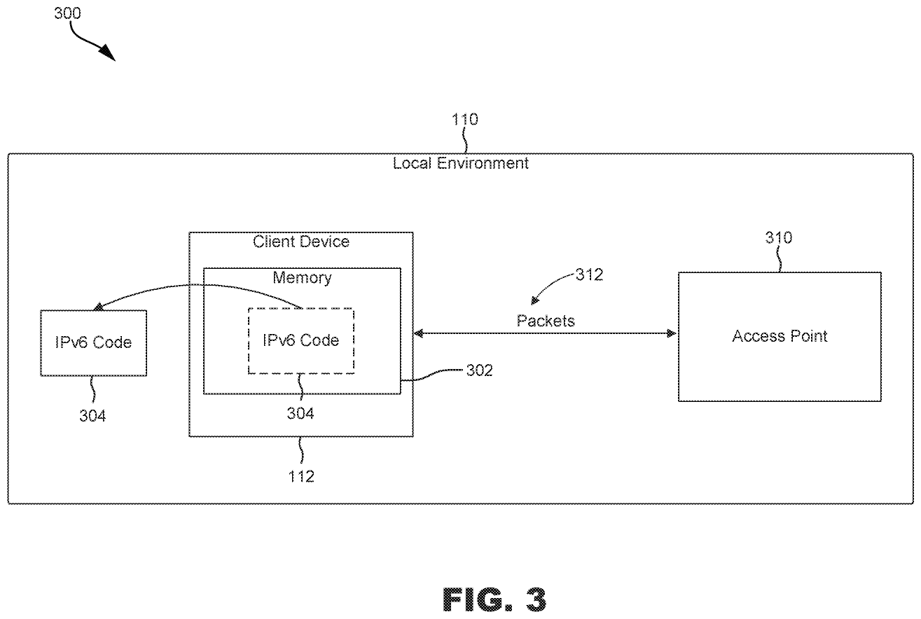

FIG. 3 illustrates a block diagram of an example use case 300 for implementing context-aware device configuration profiles, according to some examples of the present disclosure. In this example, the client device 112 can remove IPv6 code 304 from memory 302 based on a determination that the client device 112 does not need to use IPv6 (e.g., as determined from a context associated with the client device 112) to communicate with an access point 310 in the local environment 110, in order to free up space in the memory 302 for other uses. The memory 302 can include any memory device used by a process (e.g., executing/running program/code) running at the client device 112 to store data and instructions used by the process running at the client device 112 (e.g., during execution of the program/code) such as, for example and without limitation, flash memory, cache, volatile memory (e.g., random-access memory (RAM), dynamic RAM (DRAM), static RAM (SRAM), synchronous DRAM (SDRAM), double data rate (DDR) SDRAM, etc.), and/or any other type of memory used by processes/programs running at the client device 112.

The client device 112 can receive and/or capture packets 312 from an access point 310 that the client device 112 can use to connect to a network associated with the local environment 110. The client device 112 can listen for route advertisement (RA) packets from the access point 310, that the access point 310 multicasts to network devices to provide IPv6 information (e.g., IPv6 address, IPv6 address prefix, etc.) to the network devices if the access point 310 supports IPv6. For example, the client device 112 can sniff or probe packets 312 from the access point 310 and determine whether the packets 312 include an RA packet from the access point 310. If the client device 112 determines that the packets 312 include an RA packet from the access point 310, the client device 112 can determine that the access point 310 supports IPv6 based on the RA packet from the access point 310. On the other hand, if the client device 112 determines that the packets 312 do not include an RA packet from the access point 310, the client device 112 can determine that the access point 310 does not support IPv6.

In the example shown in FIG. 3, an IPv6 code 304 (e.g., software library/libraries, software package, driver, etc.) used to implement/support IPv6 at the client device 112 is loaded on the memory 302. Moreover, the client device 112 has determined that the packets 312 do not include an RA packet from the access point 310. Based on the lack of an RA packet from the access point 310, the client device 112 can determine that the access point 310 does not support IPv6. Thus, the client device 112 can determine that a context of the client device 112 includes a network connection through an access point (e.g., access point 310) that does not support IPv6. In response, the client device 112 can unload the IPv6 code 304 (and any associated data) from the memory 302 to free up space in the memory 302. The client device 112 can unload the IPv6 code 304 from the memory 302 to free up space in the memory 302 because the client device 112 does not need to run the IPv6 code 304 while connected to the access point 310 since the access point 310 does not support IPv6. This way, the client device 112 can reduce unnecessary consumption of memory space by the IPv6 code 304.

In some cases, the client device 112 can remove/eject the IPv6 code 304 from the memory 302 but keep the IPv6 code 304 stored in a storage device used to store data at the client device 112. For example, the client device 112 can keep the IPv6 code 304 in a “permanent” storage such as, for example and without limitation, a disk drive or a solid-state drive (SSD). In other cases, the client device 112 can remove/eject the IPv6 code 304 from the memory 302 and remove the IPv6 code 304 from any storage device at the client device 112. For example, the client device 112 can remove/eject the IPv6 code 304 from the memory 302 and delete the IPv6 code 304 from any storage of the client device 112. If the client device 112 later determines that it needs the IPv6 code 304 (e.g., because of a change in the context of the client device 112 such that the client device 112 needs the IPv6 code to connect to an access point that supports IPv6), the client device 112 can obtain and install the IPv6 code as needed.

In some examples, if the IPv6 code 304 is stored on a storage device (e.g., a disk drive, an SSD, etc.) of the client device 112 but, unlike the example shown in FIG. 3, the IPv6 code 304 is not loaded on the memory 302, when the client device 112 determines that the client device 112 does not need IPv6 for a network session/connection (e.g., because the network and/or associated networking device (e.g., router, access point, etc.) does not support IPv6), the client device 112 can either leave the IPv6 code 304 in the storage device for future use or remove the IPv6 code 304 from the storage device as previously described.

In some cases, to remove the IPv6 code 304 from the memory 302 without also removing IPv4 code used to implement/support the IPv4 protocol, which the client device 112 may need for network connectivity in various contexts, the code for IPv4 and IPv6 can be split/separated. For example, the client device 112 can split the drivers/libraries for IPv4 and IPv6 into an IPv4 driver/library and an IPv6 driver/library, or can receive from the remote system 102 a driver/library for IPv4 and a separate driver/library for IPv6. This way, the client device 112 can remove the IPV6 code from memory (and/or from a storage device used by the client device 112 to store data including data that is not used by any process/program running at the client device 112) but keep the IPv4 code in memory for use to communicate in IP networks using IPv4.

In the use case 300 shown in FIG. 3, IPv6 and IPv6 code 304 are used as an example of a context-based device profile adjustment provided for illustration purposes. One of ordinary skill in the art will recognize from the disclosure that other system components (e.g., software and/or hardware components) associated with other features, functionalities, protocols, standards, operations, and/or tasks can be adjusted based on context (e.g., deactivated or turned off, removed/unloaded from memory, set to a lower-operating mode, etc.), as further described herein. For example, in other cases, if a context of the client device 112 includes a network (and/or a networking device (e.g., access point, extender, mesh device, router, etc.) used by the client device 112 to connect to the network) that does not support another networking feature/scheme (e.g., Bluetooth, a WIFI version such as any of WIFI 4-7, a Matter protocol, a Thread protocol, a wireless channel, a wireless band, a WIFI or Bluetooth mesh, etc.), the client device 112 can adjust a device profile of the client device 112 to reduce or prevent one or more resources of the client device 112 (e.g., memory 304, a processor, a processor core, a power source, etc.) from being used by a hardware and/or software component that implements such networking feature/scheme.

As another example, in other cases, the client device 112 can adjust a device profile to reduce (or prevent) resource consumption at the client device 112 by a software component (e.g., an AI/ML model, a driver, a program, software libraries, an algorithm, a software package, and/or any other code) configured to perform face recognition, if the client device 112 is in a context where a regulation prohibits use of face recognition or a location of a camera of the client device 112 prevents the camera from capturing (or has less than a threshold likelihood of being able to capture) image data depicting a human face. Similarly, the client device 112 can adjust a device profile to reduce (or prevent) resource consumption at the client device 112 by a software component configured to process image data from a camera of the client device 112 to detect (e.g., from the image data) vehicles on a road(s), humans at an entrance, and/or packages delivered at a specific location, if the client device 112 is in a context where the camera does not have visibility to the road(s), the entrance, or the specific location (e.g., and thus cannot capture image data depicting the vehicles, humans, or packages for detection by the software component).

In yet another example, the client device 112 can adjust a device profile to reduce (or prevent) resource consumption at the client device 112 by one or more components (e.g., one or more hardware and/or software components) configured to provide network connectivity or illuminate a scene, if the client device 112 is in a context that includes a scene where there are no networks (and/or network devices) that the client device 112 can connect to (and thus network connectivity components are not needed/used) or that has above a threshold amount of light (and thus a component to illuminate the scene is not needed/used).

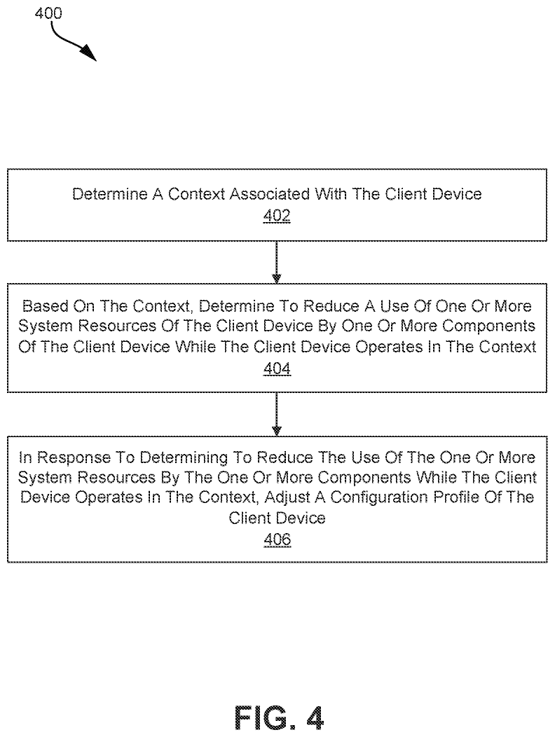

FIG. 4 is a flowchart illustrating an example method 400 for adjusting device configuration profiles based on context information, according to some examples of the present disclosure. The method 400 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 400. Further, some of the steps may be performed simultaneously, or in a different order than shown in FIG. 4, as will be understood by a person of ordinary skill in the art. The method 400 shall be described with reference to FIG. 1. However, the method 400 is not limited to that example.

At step 402, the client device 112 can determine a context associated with the client device 112. The client device 112 can determine the context based on data at the client device 112 (e.g., log data, configuration data, device/hardware data, software data, user and/or device preferences, system parameters, system information, usage data, etc.), sensor data from one or more sensors (e.g., a camera sensor, an IMU, a temperature sensor, a humidity sensor, a weight sensor, a ranging sensor, a touch sensor, a microphone, a motion sensor, etc.) of the client device 112 and/or a different device(s) (e.g., client device 114, client device 116, remote system 102, etc.), data from another client device(s) (e.g., client device 114 and/or client device 116), data from a networking device (e.g., an access point, a router, an extender, etc.), data from the remote system (e.g., content 106), data from the Internet, and/or data from any other source.

For example, the client device 112 can use sensor data (e.g., image data, IMU data, microphone data, GPS data, etc.) to determine a pose of the client device 112, a pointing direction of a sensor (e.g., a camera sensor, a microphone, a motion sensor, etc.) on the client device 112, a visibility of a camera on the client device 112, one or more characteristics of a scene (e.g., a weather, light conditions, a landscape, a type of scene such as an indoor or outdoor scene, an object or event in the scene, a human in the scene, activity in the scene, a configuration of the scene, etc.) where the client device 112 is located, a location of the client device 112 relative to other things (e.g., relative to any of the client devices 114-116, etc.), a geographic location of the client device 112, an install location of the client device 112 (e.g., a kitchen, a garage, a backyard, a front yard, an entrance, a hallway, a living room, a bedroom, an office, an elevator, a driveway, a vehicle, a robotic system, a roof, etc.), noise/sounds in a scene where the client device 112 is located, and/or other contextual information. To illustrate, the client device 112 (or the remote system 102) can use image data from one or more cameras on the client device 112 (and/or any of the client devices 114-116) to detect or recognize one or more characteristics of a scene or anything else depicted in the image data (e.g., using image processing software, object detection and/or recognition software, face recognition software, a classification model, scene detection software, landmark detection software, an AI/ML model, etc.).

In some examples, the client device 112 can determine information about a network (e.g., network features, protocols, schemes, standards, functionalities, etc.) based on network packets captured/received by the client device 112, network information reported by any of the client devices 114-116, network information provided by a networking device (e.g., an access point, a router, etc.), network data obtained from the remote system 102, etc. In some cases, the client device 112 can use a temperature sensor to determine a temperature in the environment and/or a temperature of the client device 112, a humidity sensor to determine humidity levels in the environment, etc. In some examples, the client device 112 or the remote system 102 can determine a location of the client device 112 based on an IP address associated with the client device 112, information from a service provider used by the client device 112 for network connectivity, GPS information, image data depicting a scene of the client device 112, and/or other information. In some aspects, the client device 112 can determine context information based on data (e.g., content 106) obtained from the remote system 102 such as, for example, data logging activity and/or events of the client device 112 (and/or any of the client devices 114-116), device records, user and/or system profiles, metadata, image processing outputs, sensor data processing outputs, AI/ML data, connectivity information, regulatory information, environment information, etc.

The context associated with the client device 112 can include any information about an environment (e.g., local environment 110) of the client device 112, a power context (e.g., power conditions, sources, parameters, capabilities, and/or settings) of the client device 112, device components and capabilities (e.g., software, hardware, etc.) of the client device 112, network information associated with the client device 112, regulatory information applicable to the client device 112, operating parameters of the client device 112, information about any of the client devices 114-116, resource use and/or statistics, and/or any other context information.

For example, in some cases, the context can include environment information such as, without limitation, a geographic location of the client device 112, a type of scene where the client device 112 is located (e.g., an indoor or outdoor scene, a home, an office, a road/street, a park, a garage, etc.), light and/or weather conditions in the environment where the client device 112 is located, a temperature of the client device 112 and/or an environment where the client device 112 is located, a humidity of the environment where the client device 112 is located, an install location of the client device 112 (e.g., a roof, an entrance, a living room, a hallway, a backyard, a kitchen, a bedroom, a theater, a conference room, an office, a front yard, a vehicle, a building, a structure, a park, a parking lot, a driveway, etc.), a thermal limit and/or parameter of the client device 112, a pose of the client device 112, a direction in which a sensor (e.g., a camera sensor, a microphone, etc.) of the client device 112 is pointed, a visibility/view of a camera of the client device 112, and/or any other environmental cues.

In some cases, the context can additionally or alternatively include a power context of the client device 112 such as, for example and without limitation, whether the client device 112 is powered by a battery (e.g., operating in battery mode) and/or powered by an external power source (e.g., a power outlet, an external power supply, etc.), whether the client device 112 has a solar power cell(s) used to provide at least some of the power used by the client device 112, whether the client device 112 is operating in a lower-power mode (e.g., a reduced power mode) or a higher-power mode, whether the client device 112 has intermittent power, a battery power level at the client device 112, any power limits set at or affecting the client device 112 (e.g., whether the client device 112 is powered by an external source set with a power limit, etc.), a power configuration at the client device 112, information about power needs of the client device 112, and/or any other power information associated with the client device 112.

In some cases, the context can additionally or alternatively include a network context such as, for example and without limitation, a type of network used by the client device 112 (e.g., a wireless network, an Ethernet network, a WIFI mesh network, a Bluetooth mesh network, a Matter network, a Thread network, etc.), a version of the IP protocol supported by the network (and/or a networking device such as an access point or router) used by the client device (e.g., IPv4, IPv6), any WIFI protocols/standards supported by the network and/or a networking device on the network (e.g., WIFI 4, WIFI 5, WIFI 6, WIFI 7, etc.), whether the network and/or any of the client devices 114-116 support and/or use Bluetooth data transport, a specific wireless band(s) and/or channel(s), etc.

In some cases, the context can additionally or alternatively include information about device components and/or capabilities at the client device 112 such as, for example and without limitation, network capabilities at the client device 112, information about one or more AI/ML models at the client device 112 (e.g., a neural network model size, a neural network functionality, a neural network model type, etc.), a bandwidth of the client device 112, processing capabilities at the client device 112 (e.g., object detection/recognition, face recognition, image processing, media streaming, rendering, video, sensing, etc.), hardware components at the client device 112 (e.g., memory, processor(s), storage, sensor(s), display, peripheral(s), communication, etc.), software components at the client device 112 (e.g., software packages/code/libraries/stacks/etc., AI/ML models, algorithms, drivers, etc.), device settings (e.g., restrictions/limitations, parameters, preferences, etc.), operating parameters of the client device 112, and/or any other information about device components and/or capabilities.

In some cases, the context can additionally or alternatively include regulatory information applicable to the client device 112 such as, for example and without limitation, regulations (e.g., restrictions) on use of facial recognition, wireless channel restrictions, data sovereignty restrictions, etc.

Based on the context, at step 404, the client device 112 can determine to reduce a use of one or more system resources (e.g., hardware resources) of the client device 112 by one or more components of the client device 112 while the client device 112 operates in the context. For example, the client device 112 can determine, based on the context, that one or more system components are not needed, supported, and/or used in the context and can thus determine to reduce a use of such one or more system resources while the client device 112 is in the context. As another example, the client device 112 can determine, based on the context, that the client device 112 can operate in the context without the one or more system components (or with the one or more system components operating in a reduced operating mode) and/or that not using the one or more system components (or using the one or more system components in a reduce operating mode) would not have a negative impact on a performance of the client device 112 (or would have less than a threshold impact on the performance).

In some examples, the one or more system resources can include a memory (e.g., memory 302), one or more processors, one or more processor cores, one or more power sources, one or more sensors, and/or any other hardware resources. Reducing a use of one or more system resources of the client device 112 by the one or more components of the client device 112 can include lowering, stopping, or preventing a use of the one or more resources by the one or more components. For example, reducing a use of one or more system resources of the client device 112 by the one or more components of the client device 112 can include removing/unloading a software component (e.g., software code, a program, a driver, a software library, a software stack, etc.) from a memory of the client device 112, turning off or deactivating a hardware component (e.g., a sensor, an output device such as a display or a light source, a processor or processor core, a peripheral, etc.) and/or a software component (e.g., an AI/ML model, a software service, a software feature, etc.), reducing an operating mode of a hardware and/or software component (e.g., reducing a power mode, reducing a clock speed, reducing a performance, lowering a resolution or framerate, lowering a frame buffering, throttling a component, reducing or deactivating an operating feature and/or functionality, etc.), load balancing operations between hardware components, offloading one or more operations and/or tasks to another device(s) (e.g., any of the client devices 114-116, remote system 102, etc.), or a combination thereof.

In response to determining to reduce the use of the one or more system resources by the one or more components while the client device 112 operates in the context, at step 406, the client device 112 can adjust a configuration profile of the client device 112. The adjusted configuration profile can reduce the use of the one or more system resources by the one or more components. In some examples, adjusting the configuration profile of the client device 112 can include modifying a use of resources of the client device 112 by the one or more components. For example, adjusting the configuration profile of the client device 112 can include modifying a setting and/or operating parameter of the client device 112, removing/unloading a software component from a memory of the client device 112, turning off or deactivating a hardware component and/or a software component, reducing an operating mode of a hardware and/or software component, offloading one or more operations and/or tasks to another device(s) (e.g., any of the client devices 114-116, remote system 102, etc.), or a combination thereof.

In some aspects, the client device 112 can determine a set of components that are running or set to run on the client device 112 while the client device 112 operates in the context, and select the one or more components from the set of components for adjusting in the configuration profile based on the context and one or more functionalities of the set of components. In some cases, the set of components can include a software component(s) and/or a hardware component(s).

In some examples, the one or more components can include a software component and the context can include a network environment associated with the client device 112. In some aspects, the client device 112 can determine that the network environment does not support a functionality or protocol associated with the software component, and unload or eject the software component from the memory of the client device 112. In some examples, the functionality or protocol associated with the software component can include an IP version (e.g., IPv4, IPv6), a WiFi standard (e.g., WiFi 4, WiFi 5, WiFi 6, WiFi 7, etc.), Bluetooth, Bluetooth Low Energy (BLE), Matter network protocol, Thread network protocol, a dynamic frequency selection (DFS) functionality, or a combination thereof.

In some cases, the one or more components can include a software component and/or a hardware component, the context can include a location of the client device 112 and/or an environment of the client device 112 that has a temperature above a threshold and/or a humidity above a threshold. In some aspects, the client device 112 can adjust the configuration profile of the client device 112 by reducing a clock speed of one or more processors of the client device 112, turning off or reducing an operating mode of the hardware component, unloading or ejecting the software component from memory of the client device 112, or a combination thereof.

In some examples, the client device can include a camera and determining the context associated with the client device 112 can include determining that the camera is pointed towards an indoor scene from within an indoor location or an outdoor location. In such examples, the client device 112 can adjust the configuration profile of the client device by turning off a hardware component from the one or more components that includes a light source of the camera (e.g., a flash, a light-emitting diode (LED), etc.), reducing an intensity of the light source of the camera, deactivating a software component from the one or more components configured to detect targets in an outdoor scene, and/or unloading the software component from the memory. The targets in the outdoor scene can include, for example and without limitation, packages delivered at a specific location, humans in an entrance, vehicles, an outdoor landmark(s), or a combination thereof.

In some cases, a power source from the one or more system resources can include a solar power cell, a battery, and/or a power supply having a power limit. Moreover, the context can include an environment having an ambient light below a threshold and/or intermittent power from an external power source. In such examples, the client device 112 can adjust the configuration profile of the client device 112 by turning off a hardware component from the one or more components, reducing a power mode of the hardware component and/or a software component from the one or more components, deactivating the software component, or a combination thereof.

In some cases, the context can include a restriction on a use of face recognition and/or a use of a specific wireless channel, and the client device 112 can adjust the configuration profile of the client device 112 by turning off a face recognition component from the one or more components and/or unloading or ejecting from memory a software component from the one or more components that supports wireless communications using the specific wireless channel.

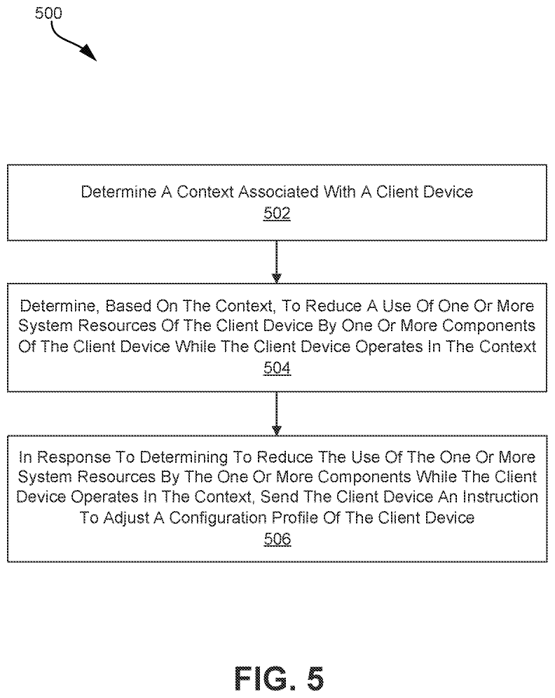

FIG. 5 is a flowchart illustrating an example method 500 for adjusting device configuration profiles based on context information, according to some examples of the present disclosure. The method 500 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 500. Further, some of the steps may be performed simultaneously, or in a different order than shown in FIG. 5, as will be understood by a person of ordinary skill in the art. The method 500 shall be described with reference to FIG. 1. However, the method 500 is not limited to that example.

At step 502, the remote system 102 can determine a context (e.g., an environment, a power context, a networking context, a processing context, a regulatory context, etc.) associated with the client device 112. In some examples, the remote system 102 can determine the context associated with the client device 112 based on sensor data (e.g., camera sensor data, microphone data, IMU data, motion sensor data, temperature sensor data, GPS data, humidity sensor data, touch sensor data, etc.) from the client device 112 and/or any of the client devices 114-116. For example, the remote system 102 can receive image data captured by a camera of the client device 112 and/or a camera of any of the client devices 114-116, and process the image data using an image processing model and/or an AI/ML model (e.g., an object detection and/or recognition model, a classification model, a scene detection model, a landmark detection model, a pattern recognition model, a face detection model, an anomaly detection model, a prediction model, a sensing and perception model, and/or any other model) to identify a scene of the client device 112, characteristics of the scene of the client device 112 (e.g., a type of scene such as an indoor or outdoor scene, scene activity, scene events, objects in the scene, landmarks in the scene, a human in the scene, a scene-distinguishing feature or item, etc.), a view and/or angle of the scene and/or of the camera sensor used to capture the image data depicting the scene, a pose of the client device 112 relative to one or more references (e.g., other devices, something in the scene, etc.), a view of a camera of the client device 112 from a location of the client device 112, visible weather features in a scene depicted in the image data, a configuration of the scene or a structure in the scene, a presence of other devices in the scene, an install location of the client device 112 (e.g., a garage, a driveway, an entrance, a living room, a kitchen, a bedroom, a hallway, a yard, a balcony, a roof, an office, a vehicle, a robotic device, a structure, a park, a building, etc.), and/or any other details about a scene and/or the client device 112 within the scene.

In some cases, the remote system 102 can additionally or alternatively determine the context associated with the client device 112 based on log data from the client device 112, an IP address associated with the client device 112, a network service provider used by the client device 112, information from the network service provider used by the client device 112 (e.g., information about a location of the client device 112, information about the client device 112, information about a user associated with the client device 112, information about the local environment 102 of the client device 112, etc.), network communications (e.g., packets, pings, requests, handshakes, notifications, etc.) of the client device 112 and/or a network associated with the local environment 102, device information (e.g., device state, device capabilities, device settings, device hardware, device operating parameters, device profile information, device events and/or logs, device software and/or software settings, etc.) reported by the client device 112 to the remote system 102, information reported by any of the client devices 114-116 (e.g., about the local environment 102, a network at the local environment 102, the client device 112, any of the client devices 114-116, etc.), Internet data, weather data, and/or any other information.

At step 504, the remote system 102 can determine, based on the context, to reduce a use of one or more system resources of the client device 112 by one or more components of the client device 112 while the client device 112 operates in the context. In some examples, the one or more system resources can include a memory, one or more processors, one or more processor cores, and/or a power source of the client device 112, among others. In some aspects, the remote system 102 can use the context and information about the client device 112 to determine that the one or more components of the client device 112 are not needed, supported, used, and/or relevant in the context, the one or more components are redundant in the context or have less than a threshold priority in the context, and/or the one or more components can be deactivated, turned off, set to a lower operating mode, or removed/unloaded from memory without negatively impacting a performance of the client device 112 in the context or without preventing the client device 112 to achieve a desired operation, behavior, performance, state, and/or functionality. The remote system 102 can then determine to reduce a use of one or more system resources of the client device 112 by the one or more components while the client device 112 operates in the context.

In some cases, the remote system 102 can first determine a set of components (e.g., hardware and/or software components) that are running or set to run on the client device 112 while the client device 112 operates in the context, and select the one or more components from the set of components based on the context and one or more functionalities of the set of components. In some cases, the remote system 102 can identify the one or more components as targets for reducing the use of the one or more system resources by the one or more components based on a comparison between the resource demands of the one or more components, the impact of the one or more components on the client device 112, and/or the functionality of the one or more components, with conditions in and/or characteristics of the context, an impact of the context on such functionality, an impact of the context on the resource demands from the one or more components, an impact of the context on a performance and/or utility of the one or more components, any conflicts between an impact of the one or more components on the client device 112 and the context on the client device 112 (and/or on an operation and/or performance of the one or more components), and/or other characteristics of the context.

In response to determining to reduce the use of the one or more system resources by the one or more components while the client device 112 operates in the context, at step 506 the remote system 102 can send the client device 112 an instruction to adjust a configuration profile of the client device. The adjusted configuration profile can reduce the use of the one or more system resources by the one or more components. In some examples, the instruction can trigger the client device 112 to adjust the configuration profile accordingly. In some cases, the instruction can specify how the client device 112 should adjust the configuration profile.

In some aspects, the instruction can include a message requesting that the client device 112 adjust the configuration profile and indicating how to adjust the configuration profile. In some examples, the instruction can include a remote command or executable script.

In some aspects, the remote system 102 can monitor the context associated with the client device 112 to determine whether any changes to the context have occurred. The remote system 102 can monitor the context based on at least some of the same type of information used to determine the context, as previously described. In some cases, the remote system 102 can additionally or alternatively probe or ping the client device 112 (and optionally any of the client devices 114-116) periodically to determine if the context has changed. If the remote system 102 detects a change in the context, the remote system 102 can determine the changed context and use the changed context to determine whether to reduce use of one or more additional system resources of the client device 112 by one or more additional components of the client device 112 (e.g., as described in step 504). If the remote system 102 determines to reduce use of one or more additional system resources of the client device 112 by one or more additional components of the client device 112, the remote system 102 can send instructions to the client device 112 to adjust the configuration profile as described in step 506.

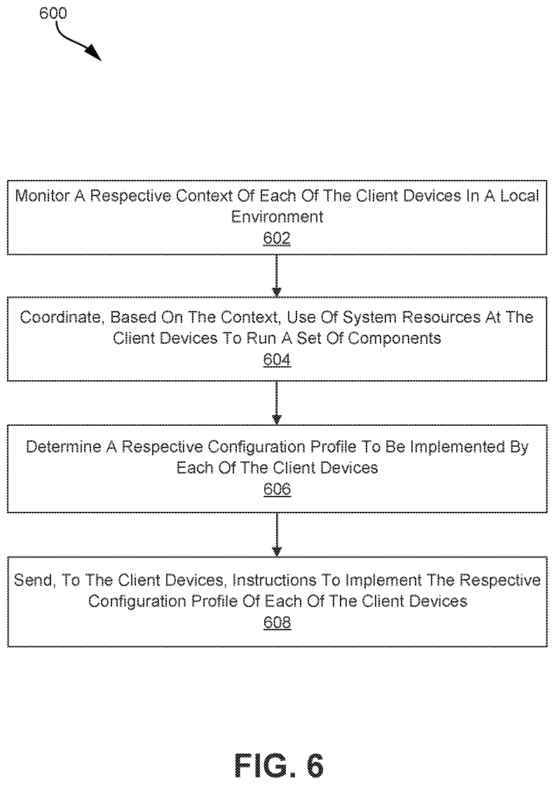

FIG. 6 is a flowchart illustrating an example method 600 for coordinating device configuration profiles across client devices based on context information. The method 600 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 600. Further, some of the steps may be performed simultaneously, or in a different order than shown in FIG. 6, as will be understood by a person of ordinary skill in the art. The method 600 shall be described with reference to FIG. 1. However, the method 600 is not limited to that example.

At step 602, the remote system 102 can monitor a respective context of each of the client devices 112-116 in the local environment 102. In some aspects, the remote system 102 can monitor whether the client devices 112-116 use or invoke one or more specific components (e.g., one or more hardware and/or software components) within a threshold period of time. For each client device that does not use or invoke a component within the threshold period of time, the remote system 102 can determine that such client device can reduce a use of one or more system resources by that component at that client device while the client device operates in the respective context. The remote system 102 can then flag that component for modification when adjusting a configuration profile of that client device, as further described herein. In some cases, to monitor use of components by the client devices 112-116, the remote system 102 can monitor activity of the client devices 112-116, can send periodic pings/probes to the client devices 112-116, and/or can periodically send requests for relevant information, such as activity and/or usage information, to the client devices 112-116, and use such information to determine if any components at any of the client devices 112-116 should be adjusted in a configuration profile to reduce resource consumption by such components.

In some cases, the remote system 102 can additionally or alternatively monitor the respective context of each of the client devices 112-116 based on sensor data from the client devices 112-116, log data from the client devices 112-116, IP addresses associated with the client devices 112-116, a network service provider used by the client devices 112-116, information from the network service provider used by the client devices 112-116 network communications of the client devices 112-116 and/or a network associated with the local environment 102, device information reported by (and/or obtained about) the client devices 112-116, information reported by any of the client devices 114-116, Internet data, weather data, and/or any other information, as previously described with respect to determining a context associated with client device 112.

At step 604, the remote system 102 can coordinate, based on the context, use of system resources at the client devices 112-116 to run a set of components (e.g., hardware and/or software components). Coordinating use of system resources at the client devices 112-116 to run the set of components can include coordinating which components (if any) should not run at any of the client devices 112-116. In some cases, coordinating use of system resources at the client devices 112-116 to run the set of components can include coordinating reduction of a use of one or more respective system resources at one or more of the client devices 112-116 by certain components (e.g., hardware and/or software components, while optionally coordinating which of the client devices 112-116 should increase or maintain the use of one or more respective system resources at such devices by the certain components, if running the certain components at any of the client devices 112-116 is desired, needed, or chosen.

In some aspects, the remote system 102 can determine which components should run or be implemented at which client device such that the use of resources at the client devices 112-116 is maximized, balanced, equitable, provides best performances and/or outcomes for the client devices 112-116, and/or are less likely to overwhelm resources at the client devices 112-116 and/or cause errors/problems at the client devices 112-116 due to resource overuse/overloading. In some cases, the remote system 102 can additionally or alternatively determine which components should run or be implemented at which client device such that the use of resources at the client devices 112-116 by such components avoids unnecessary/wasteful resource consumption and/or negative performance impacts at the client devices 112-116 and/or such that the hardware/software and operating needs and limitations of the client devices 112-116 are best matched with the use of resources by components at the client devices 112-116.

In some cases, when coordinating use of system resources at the client devices 112-116, the remote system 102 can identify a distributed scheme for distributing the use of certain resources across the client devices 112-116 by one or more components such as software and/or hardware components. In some cases, when coordinating use of system resources at the client devices 112-116, the remote system 102 can selectively match specific components with specific resources at the client devices 112-116 to reach an optimal performance of the client devices 112-116 and intelligently free up resources at the client devices 112-116 without negatively impacting the performance of the client devices 112-116 or their respective abilities to operate as desired/needed.

Based on the coordinating of the use of system resources at the client devices 112-116 to run the set of components, at step 606 the remote system 102 can determine a respective configuration profile to be implemented by each of the client devices 112-116. In some examples, a respective configuration profile for a respective client device can specify what component(s) to run or not to run at the respective client device, what component(s) should be adjusted to reduce a use of one or more system resources at the respective client device by that component(s), and/or how such adjustment should be implemented.

At step 608, the remote system 102 can send, to the client devices 112-116, instructions to implement the respective configuration profile of each of the client devices 112-116. In some examples, the instructions can trigger the client devices 112-116 to adjust the configuration profile accordingly. In some cases, the instructions can specify how each of the client devices 112-116 should implement its respective configuration profile. In some aspects, the instructions can include messages to the client devices 112-116 requesting that each of the client devices 112-116 implements its respective configuration profile and indicating how to implement the respective configuration profile. In some examples, the instructions can include remote commands or executable scripts.

### Example Computer System

Various aspects and examples may be implemented, for example, using one or more well-known computer systems, such as computer system 700 shown in FIG. 7. For example, the remote system 102 and/or the client device 112 may be implemented using combinations or sub-combinations of computer system 700. Also or alternatively, one or more computer systems 700 may be used, for example, to implement any of the aspects and examples discussed herein, as well as combinations and sub-combinations thereof.

Computer system 700 may include one or more processors (e.g., central processing units or CPUs), such as processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

In some examples, the one or more processors 704 may include a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the one or more processors 704 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 700 may also include a main or primary memory 708, such as random access memory (RAM). Main memory 708 may include one or more levels of cache. Main memory 708 may have stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may include a communication or network interface 724. Communication interface 724 may enable computer system 700 to communicate and interact with any combination of external devices, external networks, external entities, etc. (individually and collectively referenced by reference number 728). For example, communication interface 724 may allow computer system xx00 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspect 1. A client device comprising: memory; and one or more processors coupled to the memory and configured to perform operations comprising: determining a context associated with the client device; based on the context, determining to reduce a use of one or more system resources of the client device by one or more components of the client device while the client device operates in the context, the one or more system resources comprising at least one of the memory, the one or more processors, one or more processor cores, and a power source; and in response to determining to reduce the use of the one or more system resources by the one or more components while the client device operates in the context, adjusting a configuration profile of the client device, wherein the adjusted configuration profile reduces the use of the one or more system resources by the one or more components.

Aspect 2. The client device of Aspect 1, wherein the operations further comprise: determining a set of components that are running or set to run on the client device while the client device operates in the context, the set of components comprising at least one of a software component and a hardware component; and selecting the one or more components from the set of components based on the context and one or more functionalities of the set of components.

Aspect 3. The client device of any of Aspects 1 or 2, wherein the one or more components comprise a software component and the context comprises a network environment associated with the client device, wherein the operations further comprise determining that the network environment does not support a functionality or protocol associated with the software component, and wherein adjusting the configuration profile of the client device comprises unloading or ejecting the software component from the memory of the client device.

Aspect 4. The client device of Aspect 3, wherein the functionality or protocol associated with the software component comprises at least one of Internet Protocol version 6 (IPv6), WiFi 4, WiFi 5, WiFi 6, WiFi 7, Bluetooth, Bluetooth Low Energy (BLE), Matter network protocol, Thread network protocol, a dynamic frequency selection (DFS) functionality.

Aspect 5. The client device of any of Aspects 1 to 4, wherein the one or more components comprise at least one of a software component and a hardware component, wherein the context comprises at least one of a location of the client device and an environment of the client device having at least one of a temperature above a threshold and a humidity above a threshold, and wherein adjusting the configuration profile of the client device comprises at least one of reducing a clock speed of the one or more processors, turning off or reducing an operating mode of the hardware component, and unloading or ejecting the software component from the memory of the client device.

Aspect 6. The client device of any of Aspects 1 to 5, wherein the client device comprises a camera, wherein determining the context associated with the client device comprises determining that the camera is pointed towards an indoor scene from within an indoor location or an outdoor location, wherein adjusting the configuration profile of the client device comprises at least one of turning off a hardware component from the one or more components that comprises a light source of the camera, reducing an intensity of the light source of the camera, deactivating a software component from the one or more components configured to detect targets in an outdoor scene, and unloading the software component from the memory, and wherein the targets in the outdoor scene comprise at least one of delivered packages, humans, vehicles, and outdoor landmarks.

Aspect 7. The client device of any of Aspects 1 to 6, wherein the power source comprises at least one of a solar power cell, a battery, and a power supply having a power limit, wherein the context comprises at least one of an environment having an ambient light below a threshold and intermittent power from an external power source, and wherein adjusting the configuration profile of the client device comprises at least one of turning off a hardware component from the one or more components, reducing a power mode of at least one of the hardware component and a software component from the one or more components, and deactivating the software component.

Aspect 8. The client device of any of Aspects 1 to 7, wherein the context comprises a restriction on at least one of a use of face recognition and a use of a specific wireless channel, and wherein adjusting the configuration profile of the client device comprises at least one of turning off a face recognition component from the one or more components and unloading or ejecting from the memory a software component from the one or more components that supports wireless communications using the specific wireless channel.

Aspect 9. The client device of any of Aspects 1 to 8, wherein the context associated with the client device is determined based on at least one of sensor data from one or more sensors and data from a remote system comprising at least one of a remote server and a remote cloud, wherein the one or more sensors comprise at least one of a first sensor on the client device and a second sensor on a separate device, the data from the remote system comprising at least one of location information, device information, network data, log data, and information about a user associated with the client device.

Aspect 10. The client device of any of Aspects 1 to 9, further comprising one or more sensors, wherein the one or more sensors comprise at least one of a camera sensor, a temperature sensor, a humidity sensor, a motion sensor, an audio sensor, and an inertial measurement unit.

Aspect 11. A computer-implemented method for adjusting device configuration profiles, the computer-implemented method comprising: determining a context associated with a client device; based on the context, determining to reduce a use of one or more system resources of the client device by one or more components of the client device while the client device operates in the context, the one or more system resources comprising at least one of a memory, one or more processors, one or more processor cores, and a power source; and in response to determining to reduce the use of the one or more system resources by the one or more components while the client device operates in the context, adjusting a configuration profile of the client device, wherein the adjusted configuration profile reduces the use of the one or more system resources by the one or more components.

Aspect 12. The computer-implemented method of Aspect 11, further comprising: determining a set of components that are running or set to run on the client device while the client device operates in the context, the set of components comprising at least one of a software component and a hardware component; and selecting the one or more components from the set of components based on the context and one or more functionalities of the set of components.

Aspect 13. The computer-implemented method of any of Aspects 11 or 12, wherein the one or more components comprise a software component and the context comprises a network environment associated with the client device, wherein the computer-implemented method further comprises determining that the network environment does not support a functionality or protocol associated with the software component, and wherein adjusting the configuration profile of the client device comprises unloading or ejecting the software component from the memory of the client device.

Aspect 14. The computer-implemented method of Aspect 13, wherein the functionality or protocol associated with the software component comprises at least one of Internet Protocol version 6 (IPv6), WiFi 4, WiFi 5, WiFi 6, WiFi 7, Bluetooth, Bluetooth Low Energy (BLE), Matter network protocol, Thread network protocol, a dynamic frequency selection (DFS) functionality.

Aspect 15. The computer-implemented method of any of Aspects 11 to 14, wherein the one or more components comprise at least one of a software component and a hardware component, wherein the context comprises at least one of a location of the client device and an environment of the client device having at least one of a temperature above a threshold and a humidity above a threshold, and wherein adjusting the configuration profile of the client device comprises at least one of reducing a clock speed of the one or more processors, turning off or reducing an operating mode of the hardware component, and unloading or ejecting the software component from the memory of the client device.

Aspect 16. The computer-implemented method of any of Aspects 11 to 15, wherein the client device comprises a camera, wherein determining the context associated with the client device comprises determining that the camera is pointed towards an indoor scene from within an indoor location or an outdoor location, wherein adjusting the configuration profile of the client device comprises at least one of turning off a hardware component from the one or more components that comprises a light source of the camera, reducing an intensity of the light source of the camera, deactivating a software component from the one or more components configured to detect targets in an outdoor scene, and unloading the software component from the memory, and wherein the targets in the outdoor scene comprise at least one of delivered packages, humans, vehicles, and outdoor landmarks.

Aspect 17. The computer-implemented method of any of Aspects 11 to 16, wherein the power source comprises at least one of a solar power cell, a battery, and a power supply having a power limit, wherein the context comprises at least one of an environment having an ambient light below a threshold and intermittent power from an external power source, and wherein adjusting the configuration profile of the client device comprises at least one of turning off a hardware component from the one or more components, reducing a power mode of at least one of the hardware component and a software component from the one or more components, and deactivating the software component.

Aspect 18. The computer-implemented method of any of Aspects 11 to 17, wherein the context comprises a restriction on at least one of a use of face recognition and a use of a specific wireless channel, and wherein adjusting the configuration profile of the client device comprises at least one of turning off a face recognition component from the one or more components and unloading or ejecting from the memory a software component from the one or more components that supports wireless communications using the specific wireless channel.

Aspect 19. The computer-implemented method of any of Aspects 11 to 18, wherein the context associated with the client device is determined based on at least one of sensor data from one or more sensors and data from a remote system comprising at least one of a remote server and a remote cloud, wherein the one or more sensors comprise at least one of a first sensor on the client device and a second sensor on a separate device, the data from the remote system comprising at least one of location information, device information, network data, log data, and information about a user associated with the client device.

Aspect 20. A non-transitory computer-readable medium having instructions stored thereon that, when executed by a client device, cause the client device to perform a method according to any of Aspects 11 to 19.

Aspect 21. A system comprising means for performing a method according to any of Aspects 11 to 19.

Aspect 22. A computer program product having stored thereon instructions which, when executed by one or more processors, cause the one or more processors to perform a method according to any of Aspects 11 to 19.

What is claimed is:

1. A client device comprising:
memory; and
one or more processors coupled to the memory and configured to perform operations comprising:
determining a context associated with the client device;
based on the context, determining to reduce a use of one or more system resources of the client device by one or more components of the client device while the client device operates in the context, the one or more system resources comprising at least one of the memory, the one or more processors, one or more processor cores, and a power source; and
in response to determining to reduce the use of the one or more system resources by the one or more components while the client device operates in the context, adjusting a configuration profile of the client device, wherein the adjusted configuration profile reduces the use of the one or more system resources by the one or more components.

2. The client device of claim 1, wherein the operations further comprise:
determining a set of components that are running or set to run on the client device while the client device operates in the context, the set of components comprising at least one of a software component and a hardware component; and
selecting the one or more components from the set of components based on the context and one or more functionalities of the set of components.

3. The client device of claim 1, wherein the one or more components comprise a software component and the context comprises a network environment associated with the client device, wherein the operations further comprise determining that the network environment does not support a functionality or protocol associated with the software component, and wherein adjusting the configuration profile of the client device comprises unloading or ejecting the software component from the memory of the client device.

4. The client device of claim 3, wherein the functionality or protocol associated with the software component comprises at least one of Internet Protocol version 6 (IPv6), WiFi 4, WiFi 5, WiFi 6, WiFi 7, Bluetooth, Bluetooth Low Energy (BLE), Matter network protocol, Thread network protocol, a dynamic frequency selection (DFS) functionality.

5. The client device of claim 1, wherein the one or more components comprise at least one of a software component and a hardware component, wherein the context comprises at least one of a location of the client device and an environment of the client device having at least one of a temperature above a threshold and a humidity above a threshold, and wherein adjusting the configuration profile of the client device comprises at least one of reducing a clock speed of the one or more processors, turning off or reducing an operating mode of the hardware component, and unloading or ejecting the software component from the memory of the client device.

6. The client device of claim 1, wherein the client device comprises a camera, wherein determining the context associated with the client device comprises determining that the camera is pointed towards an indoor scene from within an indoor location or an outdoor location, wherein adjusting the configuration profile of the client device comprises at least one of turning off a hardware component from the one or more components that comprises a light source of the camera, reducing an intensity of the light source of the camera, deactivating a software component from the one or more components configured to detect targets in an outdoor scene, and unloading the software component from the memory, and wherein the targets in the outdoor scene comprise at least one of delivered packages, humans, vehicles, and outdoor landmarks.

7. The client device of claim 1, wherein the power source comprises at least one of a solar power cell, a battery, and a power supply having a power limit, wherein the context comprises at least one of an environment having an ambient light below a threshold and intermittent power from an external power source, and wherein adjusting the configuration profile of the client device comprises at least one of turning off a hardware component from the one or more components, reducing a power mode of at least one of the hardware component and a software component from the one or more components, and deactivating the software component.

8. The client device of claim 1, wherein the context comprises a restriction on at least one of a use of face recognition and a use of a specific wireless channel, and wherein adjusting the configuration profile of the client device comprises at least one of turning off a face recognition component from the one or more components and unloading or ejecting from the memory a software component from the one or more components that supports wireless communications using the specific wireless channel.

9. The client device of claim 1, wherein the context associated with the client device is determined based on at least one of sensor data from one or more sensors and data from a remote system comprising at least one of a remote server and a remote cloud, wherein the one or more sensors comprise at least one of a first sensor on the client device and a second sensor on a separate device, the data from the remote system comprising at least one of location information, device information, network data, log data, and information about a user associated with the client device.

10. The client device of claim 1, further comprising one or more sensors, wherein the one or more sensors comprise at least one of a camera sensor, a temperature sensor, a humidity sensor, a motion sensor, an audio sensor, and an inertial measurement unit.

11. A computer-implemented method for adjusting device configuration profiles, the computer-implemented method comprising:
determining a context associated with a client device;
based on the context, determining to reduce a use of one or more system resources of the client device by one or more components of the client device while the client device operates in the context, the one or more system resources comprising at least one of a memory, one or more processors, one or more processor cores, and a power source; and
in response to determining to reduce the use of the one or more system resources by the one or more components while the client device operates in the context, adjusting a configuration profile of the client device, wherein the adjusted configuration profile reduces the use of the one or more system resources by the one or more components.

12. The computer-implemented method of claim 11, further comprising:
determining a set of components that are running or set to run on the client device while the client device operates in the context, the set of components comprising at least one of a software component and a hardware component; and
selecting the one or more components from the set of components based on the context and one or more functionalities of the set of components.

13. The computer-implemented method of claim 11, wherein the one or more components comprise a software component and the context comprises a network environment associated with the client device, wherein the computer-implemented method further comprises determining that the network environment does not support a functionality or protocol associated with the software component, and wherein adjusting the configuration profile of the client device comprises unloading or ejecting the software component from the memory of the client device.

14. The computer-implemented method of claim 13, wherein the functionality or protocol associated with the software component comprises at least one of Internet Protocol version 6 (IPv6), WiFi 4, WiFi 5, WiFi 6, WiFi 7, Bluetooth, Bluetooth Low Energy (BLE), Matter network protocol, Thread network protocol, a dynamic frequency selection (DFS) functionality.

15. The computer-implemented method of claim 11, wherein the one or more components comprise at least one of a software component and a hardware component, wherein the context comprises at least one of a location of the client device and an environment of the client device having at least one of a temperature above a threshold and a humidity above a threshold, and wherein adjusting the configuration profile of the client device comprises at least one of reducing a clock speed of the one or more processors, turning off or reducing an operating mode of the hardware component, and unloading or ejecting the software component from the memory of the client device.

16. The computer-implemented method of claim 11, wherein the client device comprises a camera, wherein determining the context associated with the client device comprises determining that the camera is pointed towards an indoor scene from within an indoor location or an outdoor location, wherein adjusting the configuration profile of the client device comprises at least one of turning off a hardware component from the one or more components that comprises a light source of the camera, reducing an intensity of the light source of the camera, deactivating a software component from the one or more components configured to detect targets in an outdoor scene, and unloading the software component from the memory, and wherein the targets in the outdoor scene comprise at least one of delivered packages, humans, vehicles, and outdoor landmarks.

17. The computer-implemented method of claim 11, wherein the power source comprises at least one of a solar power cell, a battery, and a power supply having a power limit, wherein the context comprises at least one of an environment having an ambient light below a threshold and intermittent power from an external power source, and wherein adjusting the configuration profile of the client device comprises at least one of turning off a hardware component from the one or more components, reducing a power mode of at least one of the hardware component and a software component from the one or more components, and deactivating the software component.

18. The computer-implemented method of claim 11, wherein the context comprises a restriction on at least one of a use of face recognition and a use of a specific wireless channel, and wherein adjusting the configuration profile of the client device comprises at least one of turning off a face recognition component from the one or more components and unloading or ejecting from the memory a software component from the one or more components that supports wireless communications using the specific wireless channel.

19. The computer-implemented method of claim 11, wherein the context associated with the client device is determined based on at least one of sensor data from one or more sensors and data from a remote system comprising at least one of a remote server and a remote cloud, wherein the one or more sensors comprise at least one of a first sensor on the client device and a second sensor on a separate device, the data from the remote system comprising at least one of location information, device information, network data, log data, and information about a user associated with the client device.

20. A non-transitory computer-readable medium having instructions stored thereon that, when executed by a client device, cause the client device to perform operations comprising:
determining a context associated with the client device;
based on the context, determining to reduce a use of one or more system resources of the client device by one or more components of the client device while the client device operates in the context, the one or more system resources comprising at least one of the memory, the one or more processors, one or more processor cores, and a power source; and
in response to determining to reduce the use of the one or more system resources by the one or more components while the client device operates in the context, adjusting a configuration profile of the client device, wherein the adjusted configuration profile reduces the use of the one or more system resources by the one or more components.
